(19) United States
(12) Patent Application Publication
(10) Pub. No.: US 2006/0022839 A1
(43) Pub. Date: Feb. 2, 2006

(54) Modulation System for Communication

(76) Inventors: David R. Hall, Provo, UT (US); David B. Bartholomew, Springville, UT (US)

Correspondence Address: JEFFREY E. DALY;INTELLISERV, INC, 400 N. SAM HOUSTON PARKWAY EAST, SUITE 900, HOUSTON, TX, 77060, US

(21) Appl. No.: 10/906,151

(22) Filed: Feb. 4, 2005

Related U.S. Application Data
(63) Continuation-in-part of application No. 10/710,769, filed on Aug. 2, 2004.
(63) Continuation-in-part of application No. 10/710,790, filed on Aug. 3, 2004.

(51) Int. Cl. G01V 3/00

(52) U.S. Cl. 340/853.1

(57) ABSTRACT

A system for communication in a downhole tool string comprises an electromagnetic network integrated into the downhole tool string. The electromagnetic network comprises a plurality of band-pass filters and a plurality of network nodes. The plurality of network nodes are along the tool string. The plurality of network nodes is adapted to transmit multiple data bits simultaneously. The system also comprises a server in communication with the electromagnetic network. A method for data transmission in a downhole tool string comprises providing filters in a downhole network and providing a first network node and a second network node. The filters are band-pass filters. The method further comprises modulating a data signal, transmitting multiple bits simultaneously, filtering the data signal, and demodulating the data signal. The data signal is modulated and the multiple bits are transmitted between the first and second network nodes.

### CROSS REFERENCE TO RELATED APPLICATIONS

The present application is a Continuation-In-Part of U.S. Serial application Ser. No. 10/710,769 filed Aug. 2, 2004 to Hall, et. al.; which is herein incorporated by reference for all that it teaches. The present application is also a Continuation-In-Part of U.S. Serial application Ser. No. 10/710,790 filed Aug. 3, 2004 to Hall, et. al. which is herein incorporated by reference for all that it teaches.

### FEDERAL SPONSORSHIP

This invention was made with government support under Contract No. DE-FC26-01 NT41229 awarded by the U.S. Department of Energy. The government has certain rights in the invention.

### BACKGROUND OF THE INVENTION

The present invention relates to the field of communication in a downhole environment, particularly in a downhole network integrated into a drill string used in oil and gas exploration, or along the casings and other equipment used in oil and gas production. Gathering information of the actual operation of a drill string and the geological formations surrounding a well bore may aide drilling operations. As technology advances and the amount of information gathered by downhole tools increases, the amount of information available to drilling and production crews also increases. Several systems have been developed to transmit data from inside a well bore to the surface.

U.S. Pat. No. 6,691,779 discloses an apparatus having a remote sensing unit that is placed within a subsurface formation, an antenna structure for communicating with the remote sensing unit, a casing joint having nonconductive “windows” for allowing an internally located antenna to communicate with the remote sensing unit, and a system for obtaining subsurface formation data and for producing the formation data to a central location for subsequent analysis. A method is disclosed which includes receiving modulated data values from the remote sensing unit through the antenna system that are then transmitted to the surface where operational decisions for the well may be made.

U.S. Pat. No. 6,747,569 discloses a power transmission and data communications system for use in a gas or oil well borehole. The borehole includes a casing and a piping structure therein and at least one downhole equipment module located therein. The system provides for the power signal that is used to provide power transfer to be modulated with data and control signals that are to be transmitted to the downhole equipment located in the downhole equipment modules. In particular, the system provides for the power/data signal to be electrically coupled to the case and piping structure for transmission downhole.

U.S. Pat. No. 6,657,551 discloses a downhole telemetry system having discrete multi-tone modulation and dynamic bandwidth allocation. The downhole telemetry system comprises a surface transceiver, a cable, and a downhole transceiver coupled to the surface transceiver via the cable. The downhole transceiver communicates to the surface transceiver using discrete multi-tone (DMT) modulation to transmit telemetry information over a set of frequency sub-channels allocated for uplink communications. The surface transceiver may likewise communicate to the downhole transceiver using DMT modulation to transmit information over a set of frequency sub-channels allocated for downlink communications. The specification includes a line interface which filters a received signal, converts it to digital form, and performs time domain equalization.

U.S. Pat. No. 6,753,791 discloses a downhole telemetry system that transmits a burst-QAM uplink signal to the surface of the well. In a preferred embodiment, a downhole instrument coupled to a pair of conductors in a wireline or composite tubing string transmits a burst-QAM uplink signal to a surface system. The burst-QAM signal preferably comprises a series of data frames carrying telemetry data. Each data frame is preferably preceded by a quiet interval (when no signal is present), a timing synchronization sequence, and a training sequence.

### BRIEF SUMMARY OF THE INVENTION

A system for communication in a downhole tool string comprises an electromagnetic network integrated into the downhole tool string. The electromagnetic network comprises a plurality of band-pass filters and a plurality of network nodes. The plurality of network nodes are along the tool string. The plurality of network nodes is adapted to transmit multiple data bits simultaneously. The system also comprises a server in communication with the electromagnetic network.

The band-pass filters may reduce interference between the multiple bits. When using modulation schemes such as pi/4 differential quadrature phase shift keying (pi/4 DQPSK), quadrature amplitude modulation (QAM) or a number of other modulation schemes, the multiple bits may be represented as symbols. Interference is generally the inability to distinguish one symbol or bit from another. Interference may come from noise caused by external sources, or may come from a lack of separation of bits or symbols. The band-pass filters may filter out noise and isolate each symbol from other symbols.

The term “server” is herein intended to refer to a device for controlling communication on a network. A server generally resolves conflicts when data collisions occur, and may have control over which network node transmits at a given time, as is the case in token based networks. It is also understood that the device may execute a computer program or algorithm, and therefore many devices which execute a program or algorithm which controls network communication may be considered a server.

The system may comprise components such as rigid pipes, coiled tubing, reamers, cross over subs, saver subs, production pipe, drill collars, jars, downhole tools, or combinations thereof. Each component may comprise a band pass filter. The band-pass filters are preferably passive filters. Alternatively, the band-pass filters may be active filters. The band-pass filters may comprise inductive couplers, capacitors, inductors, resistors, transistors, batteries, amplifiers, operational amplifiers, or combinations thereof. The electromagnetic network may further comprise a plurality of signal transmission media such as wires, frequency division channels, time division channels, or code division channels.

A data signal in a computer, a node, or similar devices is often represented as a series of ones and zeros, and these ones and zeros are commonly called bits. A signal which is a series of bits is often called a digital or discrete signal. Non-digital signals are often called continuous or analog signals. Modulating a signal is the process of representing bits in an analog signal form. Demodulating a signal is the process of representing an analog signal as bits.

The multiple data bits may be transmitted using modulation schemes such as burst modulation, quadrature phase shift keying, quadrature amplitude modulation, amplitude shift keying, phase shift keying, on-off keying, phase code modulation, frequency shift keying, phase amplitude modulation, pulse phase modulation, pulse duration modulation, pulse modulation pulse width modulation, binary phase shift keying, frequency modulation, amplitude modulation, single side-band modulation, double side band, minimum shift keying, Gaussian minimum shift keying, binary frequency shift keying, orthogonal quadrature phase shift keying, differential phase shift keying, pi/4 differential quadrature phase shift keying, frequency division multiplexing, time division multiplexing, code division multiplexing, orthogonal frequency division multiplexing, or combinations thereof. The multiple data bits are preferably transmitted using pi/4 DQPSK. The server may be a device such as a rack-mounted computer, a portable computer, a desktop computer, a microprocessor, a node or combinations thereof.

The server may comprise a connection to an external network, and the external network may be the internet, a local area network, a GPS system, a satellite system, or a wireless network.

A method for data transmission in a downhole tool string comprises providing filters in a downhole network and providing a first network node and a second network node. The filters are band-pass filters, the first network node is at a first location, and the second network node is at a second location along the tool string. The method further comprises modulating a data signal, transmitting multiple bits simultaneously, filtering the data signal, and demodulating the signal. The data signal may be modulated using modulation schemes. The multiple bits are transmitted simultaneously between the first and second network nodes. The data signal is filtered using at least one of the plurality of band-pass filters.

The step of filtering the signal may preferably be performed by the plurality of band-pass filters as the signal is transmitted along the tool string. Alternatively, the step of filtering the signal may be performed before or after the step of transmitting the signal. The method may further comprise the step of providing a plurality of signal transmission media. The plurality of signal transmission media may transmit a plurality of signals modulated with data.

### BRIEF DESCRIPTION OF THE DRAWINGS

FIG. 1 is a diagram of the present invention having multiple nodes and multiple band-pass filters.

FIG. 2 is a block diagram of the present invention having multiple signal transmission media.

FIG. 3 is a flowchart of a method for data transmission in a downhole tool string.

FIG. 4 is a flowchart of an embodiment of a method for data transmission.

FIG. 5 is a diagram of multiple data transmission media transmitting multiple signals.

FIG. 6 is a bode plot of the frequency attenuation of a network.

### DETAILED DESCRIPTION OF THE INVENTION AND THE PREFERRED EMBODIMENT

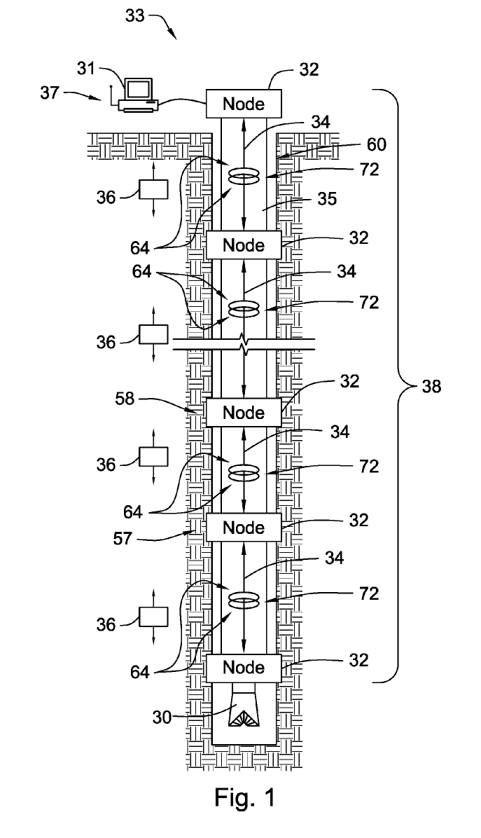

FIG. 1 is a diagram of the preferred embodiment of a system 33 for communication in a downhole tool string 35 comprising a downhole electromagnetic network 38, integrated into the downhole tool string 35. A suitable network compatible with the present invention is disclosed in co-pending U.S. Serial application Ser. No. 10/710,790 to Hall, et al., entitled “Distributed Downhole Network,” and filed Aug. 3, 2004 which is herein incorporated by reference for all that it teaches. The electromagnetic network 38 comprises multiple network nodes 32 which are adapted to transmit multiple bits simultaneously. The nodes 32 may be complex or alternatively the nodes 32 may be as simple as a network interface modem or control logic for interfacing with a network. The nodes 32 may be located at regular intervals along the tool string 35.

FIG. 1 shows the tool string 35 in a borehole 60, with a bottom hole assembly 30 attached downhole. Downhole tool string 35 may comprise various components such as rigid pipes, coiled tubing, reamers, cross over subs, saver subs, production pipe, drill collars, jars, downhole tools, or combinations thereof. Each component may comprise a band-pass filter 72.

The band pass filters 72 are preferably passive filters which comprise inductive couplers 64. A capable system for transmitting data in a downhole tool string is disclosed in U.S. Pat. No. 6,670,880 to Hall, et al., entitled “Downhole Data Transmission System,” and filed Mar. 23, 2001 which is herein incorporated by reference for all that it teaches. Other capable systems for transmitting data in a downhole tool string are disclosed in U.S. Pat. No. 6,641,434 to Boyle, et al., entitled “Wired pipe joint with current-loop inductive couplers” and filed May 31, 2002 and U.S. Pat. No. 6,688,396 to Floerke, et al., entitled “Integrated modular connector in a drill pipe” and filed Nov. 8, 2001, which are herein incorporated by reference for all that they teach. The band-pass filters 72 may comprise inductive couplers 64, capacitors, inductors, resistors, transistors, batteries, amplifiers, operational amplifiers, or combinations thereof. The band pass filters 72 may be passive filters. Passive filters typically comprise passive components such as inductive couplers, capacitors, inductors, or resistors. Passive filters may be advantageous as they may filter without the need for an additional energy source such as a battery. Alternatively, the band-pass filters may be active filters. Active filters typically comprise current or voltage sources such as batteries, amplifiers, transistors, operational amplifiers or combinations thereof. Active filters may further comprise other passive components such as capacitors, inductors, or resistors. Active filters such as a compensation filter may amplify portions of the signal 36 and may facilitate communication.

Signal 36 comprises multiple bits which are preferably transmitted using pi/4 DQPSK. Pi/4 DQPSK may be advantageous because it may not require an absolute knowledge of the phase of a carrier signal. Some modulation schemes such as QAM and quadrature phase shift keying (QPSK) may require knowledge of a reference phase, and may determine what values the current symbol represents by comparing the phase of the symbol with the reference phase. In such modulation schemes, it may be necessary to have a phase lock loop, or other mechanism to determine the reference phase before actual reception of data may occur. This may require additional hardware, a longer or more complicated preamble to packets, or both. Pi/4 DQPSK may determine what values the current symbol represents by comparing the phase of the current symbol with the phase of the last symbol received. This may help minimize hardware in the electromagnetic network 38, and may facilitate usage of packets with shorter preambles in the network. Therefore, it may be advantageous to us pi/4 DQPSK to transmit the multiple bits. However, many different modulation schemes may be used with the present invention.

Some other modulation schemes which may be used with the present invention are burst modulation, quadrature phase shift keying, quadrature amplitude modulation, amplitude shift keying, phase shift keying, on-off keying, phase code modulation, frequency shift keying, phase amplitude modulation, pulse phase modulation, pulse duration modulation, pulse modulation pulse width modulation, binary phase shift keying, frequency modulation, amplitude modulation, single side-band modulation, double side band, minimum shift keying, Gaussian minimum shift keying, binary frequency shift keying, orthogonal quadrature phase shift keying, differential phase shift keying, frequency division multiplexing, time division multiplexing, code division multiplexing, orthogonal frequency division multiplexing, or combinations thereof. The signal 36 may be transmitted through a transmission media 34 such as a wire or electrical connection. Modulation schemes such as QAM, QPSK, or pi/4 DQPSK may represent multiple bits as a symbol which may then be transmitted through a single transmission media 34, thereby simultaneously transmitting multiple bits through a single transmission media 34.

The system 33 further comprises a server 31 which may be a rack-mounted computer, a portable computer, a desktop computer, a microprocessor, a node or combinations thereof. A rack-mounted computer is typically mounted in a 1 g inch rack, which is a standard size rack wherein 1 g-inch refers to the width of the modules of the rack. The height of the modules is typically expressed as a multiple of a standard unit of height called the ‘U’. One U is 1.75 inches. An example of a rack-mounted computer may be the Sun Fire 15K, introduced by Sun Microsystems in 2001. An example of a portable computer may be a laptop computer or a hand-held computer such as a PDA. The server 31 may mediate network communications by determining which node 32 may communicate at specific times. The server 31 may also resolve conflicts such as data collision. The server 31 may comprise a connection 37 to an external network such as the internet, a local area network, a GPS system, a satellite system, or other wireless networks. A connection 37 to an external network may allow access to the electromagnetic network 38 from one or more remote locations. An external network may use different modulation schemes than those used by the electromagnetic network 38, and the server 31 may be adapted to communicate with both networks. Thus, the server 31 may act as an interface between the electromagnetic network 38 and the external network.

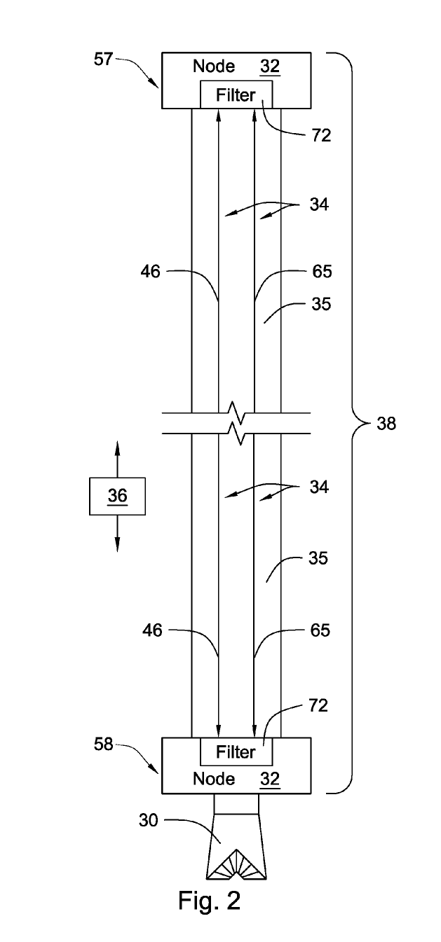

FIG. 2 is a block diagram of an alternate embodiment of a system for communication in a downhole tool string 35 comprising a downhole electromagnetic network 38, integrated into the downhole tool string 35. The downhole tool string 35 may comprise a bottom-hole assembly 30 and one section of coiled tubing, which may be as long as 30,000 feet or more. The electromagnetic network 38 may comprise two nodes 32, each node 32 may comprise a band pass filter 72. One node 32 may be at a first location 57 and the other node 32 may be at a second location 58 along a tool string 35. The electromagnetic network 38 may also comprise multiple transmission media 34, which may be multiple wires 46, 65, and which may be used as multiple signal transmission media 34. A signal 36 represents multiple bits which may be transmitted simultaneously along the multiple transmission media 34. In general, two transmission media 34 may double the number of bits which may be transmitted simultaneously. More than two transmission media 34 may also be used, which may further increase the number of bits which may be transmitted simultaneously.

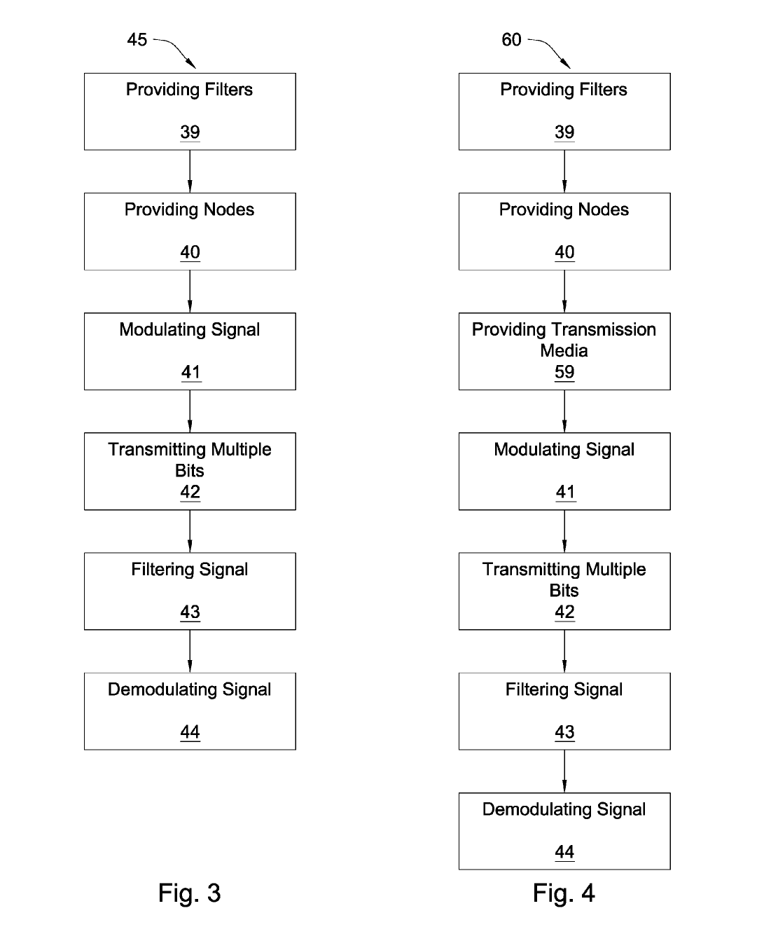

FIG. 3 is a flowchart of a method 45 for data transmission in a downhole tool string 35 and for the description of this figure references will be made to FIG. 1. The method 45 comprises the steps of providing 39 a plurality of band pass filters 72 in a downhole network 38 and providing 40 a first network node 32 at a first location 57 and a second network node 32 at a second location 58 along the tool string 35.

The method 45 further comprises the steps modulating 41 a data signal, and transmitting 42 multiple data bits. The data signal 36 may be modulated 41 using modulation schemes, and the multiple data bits are transmitted 42 simultaneously between the first and second network nodes 32.

The method 45 further comprises the step of filtering 43 the data signal 36. The data signal 36 is filtered 43 using at least one of the of band-pass filters 72. Filtering 43 the data signal 36 is preferably performed as the signal 36 is being transmitted 42 through a band-pass filter 72 comprising an inductive coupler 64 as shown in FIG. 1.

An example of filtering 43 the data signal 36 as the signal 36 is transmitted 42 may be a tool string 35 which comprises inductive couplers 64. The inductive couplers 64 may transmit the signal 36 across joints between sections of pipe, and form part of the band-pass filters. The inductive coupler 64 filters 43 the signal 36 while transmitting the signal 36 between one pipe and the next.

Alternatively, filtering 43 the data signal 36 may be performed before or after the signal 36 is transmitted 42. Filtering 43 the signal 36 may also be performed both before and after the signal is transmitted. Filtering 43 the signal 36 before, after, or both before and after the signal 36 is transmitted 42 may also be performed in conjunction with filtering 43 the signal 36 while the signal 36 is transmitted.

An example of filtering the data signal 36 before the signal 36 is transmitted may be a compensation filter, which may amplify portions of the signal 36. A compensation filter may be an active filter. Amplifying portions of the signal 36 may be desirable as portions of the signal 36 may be attenuated during transmission due to the physical characteristics of the transmission path, and amplifying those portions may compensate for attenuation. The compensation filter may be in a node 32, and the data signal 36 may be passed through the filter within the node 32 before being transmitted from the first location 57 to the second location 58.

An example of filtering the data signal 36 after the signal is transmitted may be a noise filter. Noise may come from other sources of electromagnetic radiation, and may be detected along with a data signal 36. A filter may be included in a node 32 to attenuate noise from the detected signal 36, which preserving the parts of the signal 36 which may contain information. Such a filter may be implemented using hardware, through which the signal is passed before being demodulated. Such a filter may also be implemented digitally, as a signal may be represented as a series of samples which may be filtered using software to remove the portions of the samples which contain noise.

The method 45 further comprises the step of demodulating 44 the data signal 36. Demodulating 44 the data signal 36 may represent the analog signal 36 as a series of multiple bits, and thereby may retrieve the multiple bits from the signal 36.

FIG. 4 is a flowchart of a method 60 for data transmission in a downhole tool string 35 and for the description of this figure references will be made to FIG. 1. The method comprises the steps of providing 39 a plurality of band pass filters 72 in a downhole network 38, providing 40 a first network node 32 at a first location 57 and a second network node 32 at a second location 58 along the tool string 35, modulating 41 a data signal, transmitting 42 multiple data bits, filtering 43 the data signal 36, and demodulating 44 the data signal 36 as were previously described.

The method 60 further comprises the step of providing 59 a plurality of signal transmission media 34. The plurality of transmission media 34 may be a plurality of frequency division channels. The plurality of signal transmission media may alternatively be a plurality of wires, or a plurality of code division channels. The plurality of transmission media 34 may transmit a plurality of signals 36 modulated with data. A transmission media 34 may have a range of frequencies over which it may transmit a signal 36. In general, frequency division channels are smaller ranges of frequencies into which the overall range of frequencies of a transmission media 34 may be divided. Frequency division channels may be used separately, and may transmit separate signals, though they may be transmitted down a common physical wire. Code division channels may use a code or mathematical formula to represent a signal 36 as various smaller signals spread across the range of frequencies. Multiple codes may be used to transmit multiple signals simultaneously, as the multiple codes may not interfere with one another. One advantage of using frequency division channels or code division channels may be that multiple signals 36 may be sent simultaneously through one wire or electrical conductor.

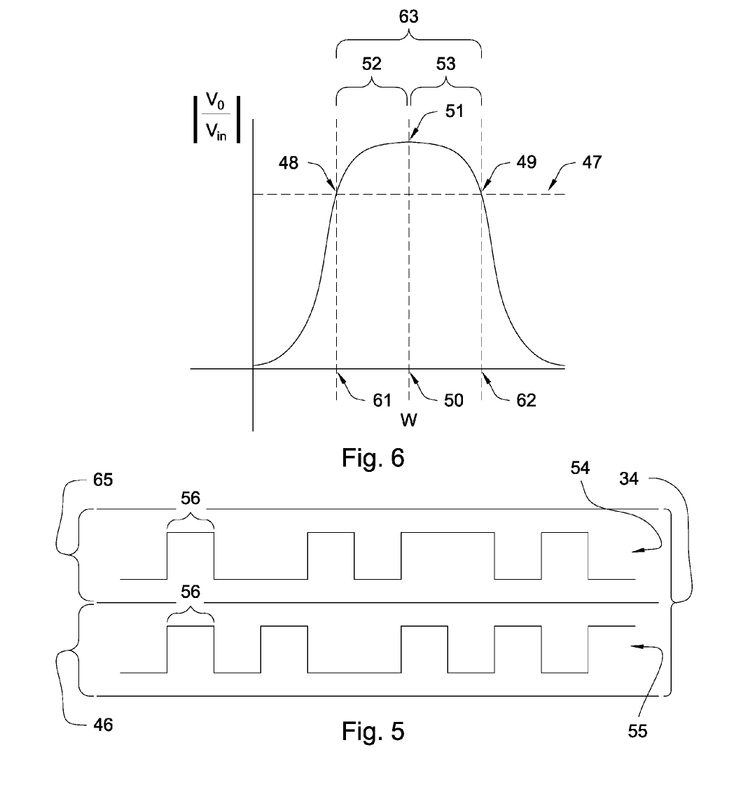

FIG. 5 shows an example of a plurality of transmission media 34 which may transmit a plurality of signals 36 and references FIG. 2. The plurality of transmission media 34 may be first and second wires 46, 64 (see also FIG. 2). Multiple data bits 56 may be divided into two parts, and each part may be represented by a signal 54, 55. A first signal 54 may be transmitted along the first wire 46, and a second signal 55 may be transmitted along the second wire 64. The first and second signals 54, 55 may each be modulated using on-off keying (OOK) which may represent one data bit 56 per signal. The two signals 54, 55 may then be transmitted simultaneously along the two wires 46, 64. This may allow two data bits 56 to be transmitted simultaneously. More complex modulation schemes such as pi/4 DQPSK may also be used which may transmit multiple bits of information as symbols. Pi/4 DQPSK may represent 2 bits per symbol, and may therefore allow two bits to be transmitted per signal, which may allow four bits to be transmitted simultaneously.

An example of a symbol may be the phase of a signal. An electromagnetic signal may oscillate in time and the point to which the oscillation has advanced in a given instant in time is called its phase. Two electromagnetic signals having the same frequency may at any point in time be at different points of oscillation, and may therefore have different phase. Phase shift keying PSK represents bits as one of two possible phases, i.e. a zero as one phase, and a 1 as another. QPSK may use four phases, and each phase may represent two bits. A sequence of two zeros may be represented as one phase, and a sequence of a zero followed by a one may be represented by a second phase. The third and fourth phases may represent a one and then a zero and two ones. Thus a symbol comprising an electromagnetic signal with one phase may be sent which may be interpreted as two bits.

FIG. 6 shows a bode plot which will be used to demonstrate an example of a plurality of transmission media which may transmit a plurality of signals 36 and for the description of this figure references will be made to FIG. 1. The plurality of transmission media 34 in this figure is two frequency division channels 52, 53. A bode plot generally plots the magnitude (|Vo/Vin|) of the gain of a system as a function of frequency (W). In general, a system may have a resonant frequency 50 at which the gain of the system is at a maximum 51. Line 47 represents a gain 3 db lower than the maximum 51. The points 48, 49 are the points at which the gain is exactly 3 db lower than the maximum 51 and are at frequencies 61, 62. Those frequencies with gains higher than the line 47 are collectively commonly called a pass-band 63, and those frequencies with gains lower than the line 47 are collectively commonly called a stop band. The pass-band 63 may be divided into two frequency division channels 52, 53. These channels 52, 53 may be used as a plurality of transmission media 34, and may transmit multiple bits represented by a plurality of signals 36 as explained previously in FIG. 5. The pass-band 63 may also be divided into more than two frequency division channels. A plurality of frequency division channels 52, 53 may be advantageous as it may increase the number of bits which may be transmitted simultaneously through a transmission media 34. A system may have multiple pass-bands 63, which may be used as multiple transmission media 34, and which may be divided into multiple frequency division channels 52, 53. In the preferred embodiment, the number of data bits 56 (see FIG. 5) which may be transmitted simultaneously may be increased by transmitting through all possible signal transmission media 34, including frequency division channels 52, 53 and wires 46, 65 (see FIG. 2). The multiple data bits 56 may be transmitted in the same direction, which may maximize the number of data bits 56 which may be transmitted in one direction. Time division multiplexing may be used to allow more than one device to transmit at different times. Alternatively, multiple data bits 56 may be transmitted through a portion of the signal transmission media 34 in one direction and another portion of the signal transmission media 34 in another direction. This may allow multiple nodes 32 to transmit simultaneously.

In general, the pass-band filters 72 reduce the interference between the multiple bits. When using modulation schemes such as pi/4 DQPSK, QAM or a number of other modulation schemes, the multiple bits may be represented as symbols. Interference is generally the inability to distinguish one symbol or bit from another. Interference may come from noise caused by external sources, or may come from a lack of separation of bits or symbols. The band-pass filters 72 may filter out noise and isolate each symbol from other symbols. For example, the inductive couplers 64 may filter the signal 36 as it is transmitted between pipe joints, and may reduce interference and noise from outside the transmission path 34. Such filters may be designed to filter out noise outside of the pass-band 63 as seen in FIG. 6.

Band-pass filters 72 may be used to isolate a signal 36 in a frequency channel 52, 53. For example, a band-pass filter 72 may filter out any frequencies which are not in the channel 52. This may allow the signal 36 which is transmitted in the channel 52 to be distinguished from other signals 36. Another band-pass filter 72 may filter out any frequencies not in the channel 53. Both band-pass filters 72 may process the original signal 36 and extract only the signal 36 in the respective channel. In this way, each signal 36 may be distinguished from other signals 36, which may reduce interference between the multiple bits.

Whereas the present invention has been described in particular relation to the drawings attached hereto, it should be understood that other and further modifications apart from those shown or suggested herein, may be made within the scope and spirit of the present invention.

What is claimed is:

1. A system for communication in a downhole tool string, the system comprising:
an electromagnetic network integrated into the downhole tool string;
the electromagnetic network comprising a plurality of band-pass filters and a plurality of network nodes along the tool string;
the plurality of network nodes being adapted to transmit multiple data bits simultaneously; and
a server in communication with the electromagnetic network.

2. The system of claim 1 wherein the downhole tool string comprises components selected from the group consisting of rigid pipes, coiled tubing, reamers, cross over subs, saver subs, production pipe, drill collars, jars, downhole tools, and combinations thereof.

3. The system of claim 2 wherein each component of the downhole tool string comprises a band-pass filter.

4. The system of claim 1 wherein the band-pass filters are passive filters or active filters.

5. The system of claim 1 wherein the band-pass filters comprise inductive couplers, capacitors, inductors, resistors, transistors, batteries, amplifiers, operational amplifiers, or combinations thereof.

6. The system of claim 1 wherein the multiple data bits are transmitted using modulation schemes selected from the group consisting of burst modulation, quadrature phase shift keying, quadrature amplitude modulation, amplitude shift keying, phase shift keying, on-off keying, phase code modulation, frequency shift keying, phase amplitude modulation, pulse phase modulation, pulse duration modulation, pulse modulation pulse width modulation, binary phase shift keying, frequency modulation, amplitude modulation, single side-band modulation, double side band, minimum shift keying, Gaussian minimum shift keying, binary frequency shift keying, orthogonal quadrature phase shift keying, differential phase shift keying, pi/4 differential quadrature phase shift keying, frequency division multiplexing, time division multiplexing, code division multiplexing, orthogonal frequency division multiplexing, and combinations thereof.

7. The system of claim 1 wherein the server is selected from the group consisting of rack-mounted computers, portable computers, desktop computers, microprocessors, nodes and combinations thereof.

8. The system of claim 1 wherein the server comprises a connection to an external network.

9. The system of claim 8 wherein the external network is selected from the group consisting of the internet, local area networks, GPS systems, satellite systems, and wireless networks.

10. The system of claim 1 wherein the electromagnetic network further comprises a plurality of signal transmission media.

11. The system of claim 10 wherein the signal transmission media are selected from the group consisting of wires, frequency division channels, and code division channels.

12. A method for data transmission in a downhole tool string, comprising:
providing a plurality of band-pass filters in a downhole network;
providing a first network node at a first location and a second network node at a second location along the tool string;
modulating a data signal;
transmitting multiple data bits simultaneously between the first and second network nodes;
filtering the data signal using at least one of the plurality of band-pass filters; and,
demodulating the data signal.

13. The method of claim 12 wherein filtering the signal is performed before or after the step of transmitting the signal.

14. The method of claim 12 wherein filtering the signal is performed by the plurality of band-pass filters as the signal is transmitted.

15. The method of claim 12 wherein the band-pass filters are passive filters or active filters.

16. The method of claim 12 wherein the band-pass filters comprise inductive couplers, capacitors, inductors, resistors, transistors, or combinations thereof.

17. The method of claim 12 wherein the data is modulated using modulation schemes selected from the group consisting of burst modulation, quadrature phase shift keying, quadrature amplitude modulation, amplitude shift keying, phase shift keying, on-off keying, phase code modulation, frequency shift keying, phase amplitude modulation, pulse phase modulation, pulse duration modulation, pulse modulation pulse width modulation, binary phase shift keying, frequency modulation, amplitude modulation, single side-band modulation, double side band, minimum shift keying, Gaussian minimum shift keying, binary frequency shift keying, orthogonal quadrature phase shift keying, differential phase shift keying, π/4 differential quadrature phase shift keying, frequency division multiplexing, time division multiplexing, code division multiplexing, orthogonal frequency division multiplexing, and combinations thereof.

18. The method of claim 12 wherein the method further comprises the step of providing a plurality of signal transmission media.

19. The method of claim 18 wherein the signal transmission media are selected from the group consisting of wires, frequency division channels, and code division channels.

20. The method of claim 18 wherein the plurality of signal transmission media transmits a plurality of signals modulated with data.
